(19) United States
(12) Patent Application Publication
(10) Pub. No.: US 2025/0357755 A1
(43) Pub. Date: Nov. 20, 2025

(54) ELECTRICAL SYSTEM WITH A VOLTAGE CONVERTER AND AN EXTERNAL CONTROL CIRCUIT FOR CONTROLLING THE CONVERTER

(71) Applicant: Schaeffler Technologies AG & Co. KG, Herzogenaurach (DE)

(72) Inventors: Jean CANNAVO, Toulouse (FR); Thierry BAVOIS, Toulouse (FR)

(21) Appl. No.: 19/098,380

(22) Filed: Apr. 2, 2025

(30) Foreign Application Priority Data
May 14, 2024 (FR) 2404888

(51) Int. Cl. H02J 1/02; H02M 1/36

(52) U.S. Cl. CPC H02J 1/02; H02M 1/36; H02J 2310/48

(57) ABSTRACT

The invention relates to an on-board electrical system, comprising at least one main battery (1), a primary network (VR1) directly supplied with power from the main battery, a voltage converter (3) supplying power to a secondary network (VR2), the voltage converter being supplied with power from the main battery via a first supply line (2), the first supply line comprising at least one smoothing filter (22), the system being characterized in that it comprises an external control circuit (4) for controlling the converter, which circuit is configured to selectively activate or deactivate the operation of the voltage converter so as to minimize the voltage drop on the primary network when the voltage converter is started up.

The present invention relates to an electrical system with a voltage converter. The electrical system comprises a main battery and the voltage converter is supplied with power from the main battery.

When the voltage converter is started up, oscillations and a large inrush current to the main battery, which leads to a voltage drop on the network supplied with power from the main battery, occur. In voltage converters, on-off switching is used, which controls the flow of current through one or more load inductors.

According to certain known solutions, an inductive filter is placed at the output of the main battery in order to smooth the current and a reduction in the voltage drop phenomenon and in the oscillations induced by the chopped control employed in the voltage converter.

In the case of quasi-resonant voltage converters, the control switching has a certain flexibility and is not performed at regular intervals. The electromagnetic spectrum of the possible disturbances produced by the chopped control of the resonant voltage converter is therefore relatively wide.

The switching operations and the transients resulting therefrom generally cause electromagnetic noise, in particular disturbances conducted over the entire on-board network, degrading performance from the point of view of the electromagnetic compatibility of the system including the voltage converter.

Some have tried to refine the inductive filtering solution placed between the main battery and the voltage converter by using a filter known as a Pi filter. Such a Pi filter comprises an inductor connected in series on the line and placed between an upstream first capacitor and a downstream second capacitor, each capacitor being interposed between the line and ground.

Such a solution involving a Pi filter allows performance in terms of reduction of transients to be increased to a certain extent and over a wider frequency spectrum, but does not completely solve the problem.

The inventors have sought to further improve the situation, and in particular to reduce the voltage drop phenomenon and the oscillations induced by the chopped control of the voltage converter.

To this end, what is proposed is an on-board electrical system, comprising at least one main battery, a primary network directly supplied with power from the main battery, a voltage converter supplying power to a secondary network, the voltage converter being supplied with power from the main battery via a first supply line, the first supply line comprising at least one smoothing filter, the system being characterized in that it comprises an external control circuit for controlling the converter, which circuit is configured to selectively activate or deactivate the operation of the voltage converter so as to minimize the voltage drop on the primary network when the voltage converter is started up.

By virtue of these arrangements, the selective control for activating the voltage converter makes it possible to turn on said converter progressively over the few hundred milliseconds between the beginning of the sequence and full-capacity operation of the voltage converter.

This results in a significant decrease in the voltage drop caused by the first inrush current and a decrease in the amplitude of the oscillations and transients that follow.

In this way, it is possible, incidentally, to downsize the smoothing filter that is placed between the battery and the voltage converter.

With regard to the expression “on-board electrical system”, the qualifier “on-board” indicates that the electrical system is intended to be installed on a mobile machine or at least on a movable machine, not supplied with power by a mains electricity grid.

According to one embodiment, the external control circuit for controlling the converter is configured to deactivate the operation of the voltage converter if a value of the instantaneous voltage of the first supply line falls below a first threshold.

The voltage drop on the supply line of the voltage converter is therefore limited. Advantageously, the impact on the other consumers connected to the primary network, resulting from the phenomenon of the voltage converter being started up, is reduced.

According to one embodiment, the external control circuit for controlling the converter is configured to reactivate the operation of the voltage converter if the value of the instantaneous voltage of the first supply line rises above a second threshold.

The operation of the converter is reactivated to continue the start-up sequence to ultimately reach full-capacity operation.

There is therefore an alternation between operation and non-operation during the start-up phase of the voltage converter, said start-up phase lasting at most a few hundred milliseconds.

According to one embodiment, the external control circuit for controlling the converter is a digital circuit. The use of a small microcontroller or a specific ASIC may satisfy the function to be fulfilled in this case.

According to one embodiment, the external control circuit for controlling the converter takes the form of wired logic and comprises a hysteresis comparator.

As a result, a basic solution that is highly reliable and of simple design is used, there being no need to develop a specific digital circuit or software.

According to one option, the first and second thresholds of the comparator are defined with respect to an averaged smoothed value of the first supply line. As such, instead of using absolute values, the high and low thresholds are defined with respect to a relative value obtained by averaging over a sliding window. Using threshold values based on a relative reference allows better adaptation to the situation and to the current state of charge of the main battery.

According to one embodiment, the positive terminal of the hysteresis comparator is connected to the instantaneous voltage of the first supply line and the negative terminal of the hysteresis comparator is connected to an output of an RC filter that filters the instantaneous voltage of the first supply line, or the negative terminal of the hysteresis comparator is connected to the instantaneous voltage of the first supply line and the positive terminal of the hysteresis comparator is connected to an output of an RC filter that filters the instantaneous voltage of the first supply line.

It is possible to obtain this average value very simply by using an analog RC low-pass filter, which will be described below. A cut-off frequency of the order of 1 kHz for this filter may be suitable.

According to one embodiment, the voltage converter is a quasi-resonant voltage converter. The modulated control performed by the external control circuit allows the amplitude of the oscillations to be reduced regardless of the control logic implemented in the voltage converter, and this applies for a wide spectrum of possible disturbance frequencies.

Moreover, it will be noted that the control modulated by the external control circuit may be applied to any type of voltage converter.

The present invention also relates to a method implemented in an on-board electrical system as described above, the method making provision for selectively activating and deactivating the voltage converter from an inactive state to a steady operating state, the method comprising:
deactivating the operation of the voltage converter if a value of the instantaneous voltage of the first supply line falls below a first threshold,
reactivating the operation of the voltage converter if the value of the instantaneous voltage of the first supply line rises above a second threshold.

There is therefore an alternation between operation and non-operation during the start-up phase of the voltage converter. The start-up phase may last for a few hundred milliseconds, or even less than 100 ms in some cases.

As already mentioned, the first threshold and the second threshold may be, according to one option, fixed thresholds or, according to another option, thresholds that are defined relatively with respect to an average voltage of the primary network.

The present invention also relates to a vehicle comprising at least one on-board electrical system as described above.

The invention will be further detailed through the description of non-limiting embodiments and on the basis of the attached figures, which illustrate variants of the invention, and in which:

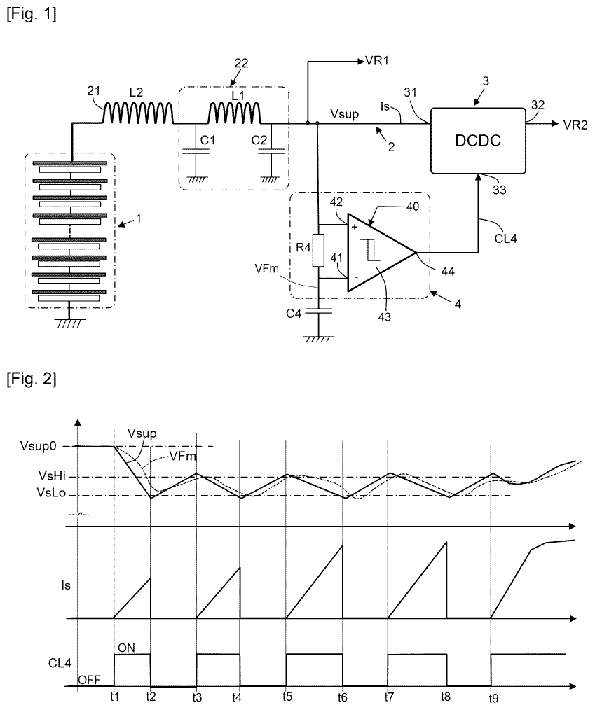

FIG. 1 schematically illustrates one example of an electrical circuit of the proposed system;

FIG. 2 illustrates one example of a timing diagram illustrating the proposed method.

The same references denote identical or similar elements throughout the various figures. For the sake of the clarity of the disclosure, some elements are not necessarily shown to scale.

FIG. 1 illustrates an on-board electrical system that comprises a main battery 1 and a voltage converter 3 supplied with power from the main battery via a first supply line 2.

The voltage converter 3 is referred to as a DC-DC converter in the jargon. In a typical configuration, the voltage converter has a voltage output value that is lower than its input (step-down DC-DC converter), however it is not ruled out to have the reverse configuration (step-up DC-DC converter).

In the present context, the invention presented below is particularly relevant in the case of a quasi-resonant voltage converter. A quasi-resonant voltage converter is a piece of equipment that is known per se, and therefore not described in detail here. The reader may refer, for example, to the document U.S. Pat. No. 5,903,448.

By way of example, the main battery 1 may be a traction battery that is capable of moving a vehicle in zero emission mode. The vehicle may be a light vehicle, a recreational vehicle, a passenger vehicle, a utility vehicle; there is no limit on the type of vehicle that may be considered. The nominal voltage of the main battery may typically be 12 or 24 volts for a conventional vehicle, or greater than 50 volts, most often greater than 100 volts, for an electric vehicle.

A primary network VR1 is supplied with power directly from the main battery and carries the voltage Vsup of the main battery 1. The first supply line, which is denoted 2, forms part of the primary network VR1. Other consumers may be connected to the primary network VR1.

A secondary network VR2 is supplied with power directly from the output 32 of the voltage converter 3. The secondary network VR2 may comprise an auxiliary battery having a nominal voltage that corresponds to the nominal voltage of the secondary network. The secondary network VR2 may supply power to a plurality of auxiliary consumers.

The first supply line 2 comprises an inductor 21, which is denoted L2, and a smoothing filter 22. The smoothing filter 22 is a Pi filter with a series inductor L1, an upstream first capacitor C1 and a downstream second capacitor C2. Each capacitor C1, C2 is interposed between the supply line and ground.

The current that enters the input 31 of the voltage converter is denoted Is. In the timing diagram in FIG. 2, the middle curve shows the variation of the current Is consumed by the voltage converter.

An activation input, which is designated 33, is provided on the voltage converter. In the example illustrated, when the activation input is in the low state, the converter is activated and operates, whereas, by contrast, when the activation input is in the high state, the converter is deactivated and its operation is stopped. The responsiveness to the activation input is immediate.

Advantageously, the system according to the present invention comprises an external control circuit 4 for controlling the converter, which circuit is configured to selectively activate or deactivate the operation of the voltage converter.

In the example illustrated, a wired analog circuit is used. More specifically, in this case, the external control circuit 4 comprises a hysteresis comparator, which is designated 43.

The hysteresis comparator 43 comprises a positive input 42 (also referred to as a positive terminal), a negative input 41 (also referred to as a negative terminal), and an output 44.

The positive input 42 is connected to the first supply line and consequently receives the instantaneous voltage Vsup prevailing in the first supply line 2.

The output 44 of the voltage converter is connected to a control line CL4 that directly activates the activation input 33 of the voltage converter.

The negative input 41 receives a voltage, which is denoted VFm.

This voltage VFm represents the output of a low-pass filter, for example an RC filter.

More specifically, a resistor R4 is provided, the upper terminal of which is connected to the first supply line and the lower terminal of which is connected to the negative input 41 of the comparator. Furthermore, a capacitor C4 is connected to the negative input 41 of the comparator, on the one hand, and to ground, on the other hand.

The components R4 and C4 therefore form a conventional analog low-pass filter. The capacitance and resistance values may be chosen to so as to obtain a time constant of the order of 0.16 milliseconds, i.e. a cut-off frequency of 1 kHz. It is the midpoint between the components R4 and C4 that forms the output of the filter.

The operating principle is as follows.

The external control circuit 4 for controlling the converter deactivates the operation of the voltage converter if a value of the instantaneous voltage Vsup of the first supply line falls below a first threshold VsLo.

The first threshold VsLo may be a predefined voltage value. The first threshold VsLo may be a value that is a function of a value resulting from a sliding window average, as in the case of the output of the RC filter discussed above. In this case, it may be said that the first threshold VsLo is floating.

The external control circuit 4 for controlling the converter reactivates the operation of the voltage converter if a value of the instantaneous voltage Vsup of the first supply line rises above a second threshold VsHi.

Similarly to the first, the second threshold VsHi may be a predefined voltage value or may be a value that is a function of a value resulting from a sliding window average, as in the case of the output of the RC filter discussed above.

In FIG. 2, the voltage Vsup prevailing in the first supply line 2 is initially at the value Vsup0 before any current is drawn by the voltage converter.

The voltage VFm averaged by the filter R4-C4 has been shown by a dotted line.

There is a first activation phase of the voltage converter between the times t1 and t2. At the time t1, the comparator 43 receives a logic command via its supply line 40.

The current flowing through the resistor R4 is zero, and as a result the positive input 42 and the negative input 41 are substantially at the same voltage and the output of the comparator 44 is in the low state.

From the time t1, the current Is consumed by the converter increases and the voltage Vsup decreases.

At the time t2, the positive input 42 becomes significantly lower than the negative input 41 and the output of the comparator changes to the low state. Therefore, the operation of the converter is stopped (CL4 is in the logic OFF state).

From the time t2, the voltage Vsup increases. By virtue of the filter R4-C4, and of the hysteresis of the comparator, the output 44 of the comparator remains in the low state until the time t3.

At the time t3, the negative input 41 becomes significantly lower than the positive input 42 and the output of the comparator changes to the high state, this reactivating the operation of the converter, which draws current again (CL4 is in the logic ON state).

From the time t3, the current Is consumed by the converter increases and the voltage Vsup decreases.

At the time t4, the positive input 42 becomes significantly lower than the negative input 41 and the output of the comparator changes to the low state. Therefore, the operation of the converter is stopped.

From the time t4, the voltage Vsup increases. By virtue of the filter R4-C4, and of the hysteresis of the comparator, the output 44 of the comparator remains in the low state until the time t5.

At the time t5, the negative input becomes significantly lower than the positive input and the output of the comparator changes to the high state, this reactivating the operation of the converter, which draws current again.

From the time t5, the current Is consumed by the converter increases and the voltage Vsup decreases.

At the time t6, the positive input becomes significantly lower than the negative input and the output of the comparator changes to the high state. Therefore, the operation of the converter is stopped.

From the time t6, the voltage Vsup increases. By virtue of the filter R4-C4, and of the hysteresis of the comparator, the output 44 of the comparator remains in the low state until the time t7.

At the time t7, the negative input 41 becomes significantly lower than the positive input 42 and the output of the comparator changes to the high state, this reactivating the operation of the converter, which draws current again.

According to the same logic, at the time t8, the operation of the converter is stopped.

It is reactivated at the time t9, from which the voltage Vsup no longer falls below the first threshold VsLo.

The start-up sequence of the converter is then completed.

As an alternative to the wired logic solution, provision may be made for the external control circuit to be based on a microcontroller and a digital solution that may remain relatively simple, performing digital filtering and a digital comparison to deliver the output sent on the control line CL4.

FIG. 1 illustrates a solution with a single comparator. It is also possible to use a solution with two comparators, a first comparator for comparing Vsup with a low switching threshold VsLo and a second comparator for comparing Vsup with a high switching threshold VsHi. An AND gate and/or an OR gate may be provided at the output of the two comparators so as to activate the control line CL4.

Regarding the activation and deactivation logic of the voltage converter and the output logic of the comparator, it may be necessary to add an inverting gate between the output of the comparator and the activation input of the voltage converter.

Similarly, depending on a particular configuration of interest, the positive and negative terminals may be inverted depending on the desired control polarity of the converter.

By virtue of the selective activation logic of the voltage converter proposed here, it is possible to dimension the series inductor 21 and the Pi filter 22 as accurately as possible, making it possible to reduce the cost of these power components, and optimize the overall cost of the solution while improving the performance thereof in terms of electromagnetic compatibility.

1. An on-board electrical system, comprising at least one main battery (1), a primary network (VR1) directly supplied with power from the main battery, a voltage converter (3) supplying power to a secondary network (VR2), the voltage converter being supplied with power from the main battery via a first supply line (2), the first supply line comprising at least one smoothing filter (22), the system being characterized in that it comprises an external control circuit (4) for controlling the converter, which circuit is configured to selectively activate or deactivate the operation of the voltage converter so as to minimize the voltage drop on the primary network when the voltage converter is started up, and wherein the first and second thresholds (VsLo, VsHi) are defined with respect to an averaged smoothed value (VFm) of the first supply line that is representative of a signal output from the smoothing filter (22), wherein the external control circuit (4) for controlling the converter is configured to deactivate the operation of the voltage converter if a value of the instantaneous voltage (Vsup) of the first supply line falls below a first threshold (VsLo), and wherein the external control circuit (4) for controlling the converter is configured to reactivate the operation of the voltage converter if the value of the instantaneous voltage (Vsup) of the first supply line rises above a second threshold (VsHi).

2. The on-board electrical system as claimed in claim 1, wherein the external control circuit (4) for controlling the converter is a digital circuit.

3. The on-board electrical system as claimed in claim 1, wherein the external control circuit (4) for controlling the converter takes the form of wired logic and comprises a hysteresis comparator.

4. The on-board electrical system as claimed in claim 3, wherein the positive terminal of the hysteresis comparator is connected to the instantaneous voltage (Vsup) of the first supply line and the negative terminal of the hysteresis comparator is connected to an output of an RC filter that filters the instantaneous voltage (Vsup) of the first supply line, or the negative terminal of the hysteresis comparator is connected to the instantaneous voltage (Vsup) of the first supply line and the positive terminal of the hysteresis comparator is connected to an output of an RC filter that filters the instantaneous voltage (Vsup) of the first supply line.

5. The on-board electrical system as claimed in claim 1, wherein the voltage converter is a quasi-resonant voltage converter.

6. A method implemented in an on-board electrical system as claimed in claim 1, the method making provision for selectively activating and deactivating the voltage converter from an inactive state to a steady operating state, method comprising: the
deactivating the operation of the voltage converter if a value of the instantaneous voltage (Vsup) of the first supply line falls below a first threshold (VsLo),
reactivating the operation of the voltage converter if the value of the instantaneous voltage (Vsup) of the first supply line rises above a second threshold (VsHi).

7. A vehicle comprising at least one on-board electrical system as claimed claim 1.
